(19) United States
(12) Patent Application Publication
(10) Pub. No.: US 2018/0259477 A1
(43) Pub. Date: Sep. 13, 2018

(54) Electrochemical Gas Sensor

(71) Applicant: Figaro Engineering Inc., Minoo-shi (JP)

(72) Inventor: Masakazu Sai, Minoo-shi (JP)

(21) Appl. No.: 15/759,991

(22) PCT Filed: Aug. 18, 2016
(86) PCT No.: PCT/JP2016/074054

§ 371 Date: Mar. 14, 2018

(30) Foreign Application Priority Data
Sep. 17, 2015 (JP) 2015-183700
Oct. 8, 2015 (JP) 2015-199967

(51) Int. Cl. G01N 27/407; B01D 53/04

(52) U.S. Cl. CPC G01N 27/4072; G01N 27/4077; B01D 2253/25; B01D 2253/102; B01D 53/04

(57) ABSTRACT

The electrochemical gas sensor comprises a polymer solid electrolyte membrane, a detection electrode, a counter electrode, an electrically conductive and porous gas diffusion layer covering the detection electrode and has no water reservoir. And the gas diffusion layer or active carbon in a filter is made hydrophilic. The endurance in dry atmospheres is improved.

### FIELD OF THE INVENTION

The invention relates to an electrochemical gas sensor.

### PRIOR ART

Electrochemical gas sensors having a proton conductor membrane, a detection electrode on one surface of the membrane, a counter electrode on the other surface of the membrane, and hydrophobic carbon fiber sheets comprising carbon and PTFE (polytetrafluoro ethylene) and covering the electrodes have been known (the patent document 1: JP2006-84319A). The electrochemical gas sensors have a water reservoir, and the hydrophobic carbon fiber sheets evacuate liquid water which has spread from the water reservoir.

The patent document 2 (US2015/1076A) discloses an electrochemical gas sensor having a hydro gel covering the detection electrode, the counter electrode, and the reference electrode. The hydro gel reserves water and serves as a water reservoir. The patent document 3 (JP2010-241648A) discloses making active carbons hydrophilic. The patent document 4 (JP2007-503992) discloses that acid treated active carbon have more efficient in removing siloxanes than untreated active carbon.

### CITATION LIST

### Patent Documents

Patent Document 1: JP2006-84319A

Patent Document 2: US2015/1076A

Patent Document 3: JP2010-241648A

Patent Document 4: JP2007-503992

### SUMMARY OF THE INVENTION

### Problems to be Solved by the Invention

Electrochemical gas sensors without a water reservoir tend to reduce to some degree their sensitivity in a dry atmosphere due to the decrease in electric conductivity of the polymer solid electrolyte and the decrease in the activity of the detection electrode. For example, the detection of CO needs water, because the following reaction in the detection electrode is used. Further, when the electric conductivity of the polymer solid electrolyte decreases, the output current or the output voltage decreases.

CO+H₂O→CO₂+2H⁺+2e⁻

The object of the invention is to improve the durability of electrochemical gas sensors without a water reservoir in dry atmospheres.

A subsidiary object of the invention is to prevent the gas sensors from the sensitivity loss in dew condensed atmospheres.

### Means for Solving the Problems

An electrochemical gas sensor according to the invention comprises a polymer solid electrolyte membrane, a detection electrode in contact with said solid electrolyte membrane, a counter electrode in contact with said solid electrolyte membrane and separate from and not in contact with the detection electrode, an electrically conductive and porous gas diffusion layer covering the detection electrode in an opposite side to said solid electrolyte membrane, and a filter. The electrochemical gas sensor is not provided with a water reservoir, and the gas diffusion layer or the filter is hydrophilic.

First, the hydrophilization of the gas diffusion layer is described. As is shown in FIG. 3 and FIG. 4, the hydrophilization of gas diffusion layers improves the durability in dry atmospheres. The gas diffusion layer is a thicker element than the solid polymer electrolyte membrane, the detection electrode, and the counter electrode and is capable of reserving more plenty of water than them. The reserved water gradually vaporizes in dry atmospheres or migrates into the electrodes and solid polymer electrolyte membrane, and therefore, the gas sensitivity is kept. The electrochemical gas sensor according to the invention has high durability in dry atmospheres without a water reservoir (FIGS. 3 and 4). In general, while electrochemical gas sensors reduce the sensitivity when kept in dry atmospheres for a long time, the sensitivity recovers when the gas sensors are returned in normal humidity atmospheres.

Preferably, said detection electrode is provided on one surface of said solid electrolyte membrane, and said counter electrode is provided on the other surface of said solid electrolyte membrane. Said gas diffusion layer covering said detection electrode is a first gas diffusion layer, and the gas sensor further comprises a second gas diffusion layer which is electrically conductive and porous and covers said counter electrode on an opposite side to said solid electrolyte membrane, and said first gas diffusion layer and said second gas diffusion layer are both made hydrophilic. Since the first gas diffusion layer and the second gas diffusion layer are both hydrophilic, a plenty of water is reserved in the gas diffusion layers so that the durability to dry atmospheres improves.

Usually, in the gas diffusion layer, carbon is bound by an organic binder. In fuel cells, the gas diffusion layers have hydrophobic polymer binders such as PTFE (polytetrafluoro ethylene) to prevent water flooding, and the gas diffusion layers are hydrophobic. Preferably, said first gas diffusion layer and said second gas diffusion layer are made hydrophilic both by an organic binder free of alkaline metal ions and comprising a water-insoluble hydrophilic polymer. Such a hydrophilic binder may be cellulose, PVA (polyvinyl alcohol), vinyl acetate polymer, copolymers of PVA and vinyl acetate, hemicellulose, starch, pectin, alginic acid, polyvinyl pyrrolidone, polyacryl amide, H⁺ type polyacrylic acid, H⁺ type polymethacrylic acid, H⁺ type polymaleic acid, sulfonated condensed bisphenols, lignin, or the like. These polymers are made hydrophilic due to a hydroxy group, an ether group, a carboxy group, a ketone group, an amido group, a H⁺ type sulfonic acid group, a sulfonyl group, an ester group, or the like. Further, the degree of hydrophilicity depends mainly upon the content of hydrophilic groups, and the species of hydrophilic groups and the stability of polymer crystals and the like influence the hydrophilicity. For example, hydroxy group is more hydrophilic than ester group.

By the way, some of the carboxy cellulose, vinyl acetate, hemicellulose, starch, pectin, alginic acid, polyvinyl pyrrolidone, polyacryl amide, H⁺ type polyacrylic acid, H⁺ type polymethacrylic acid, H⁺ type polymaleic acid, sulfonated condensed bisphenols, sulfonated or carbonated lignin are water-soluble, but they may be made water-insoluble by bridging or the like. Other than bridging, copolymerization with a hydrophobic polymer and graft polymerization with a hydrophobic polymer may make the binder water-insoluble. Further, hydrophilic polymers may be made water-insoluble by partly substituting hydrophobic ester group for hydrophilic hydroxy group, partly substituting fluorine atoms, or the like for hydrogen atoms in the carbon framework. The carbon may be carbon fiber, carbon black, active carbon, graphite, or the like.

When the binder includes alkaline metal ion, the binder might be swollen with absorbing a plenty of water in dew condensed atmospheres due to the osmotic pressures. For example, Na⁺ type polyacrylic acid swells in dew condensed atmospheres by absorbing a plenty of water. And the swelling of the binder results in the expansion of the gas diffusion layer and may result in changes of gas sensor performances. Further, a water-soluble binder might migrate in water in dew condensed atmospheres. Therefore, the organic binder is preferably a hydrophilic organic binder free of alkaline metal ions and comprising a water-insoluble hydrophilic polymer. When the binder does not include alkaline metal ions and is water-insoluble, the gas diffusion layer does not swell in dew condensed atmospheres and the binder does not migrate. By the way, some polymer of H⁺ type and not including metal ions such as Na⁺, for example, polyacrylic acid, polymethacrylic acid, carboxylic acid type polymers such as poly-maleic acid, sulfonic acid polymers such as sulfonated lignin, sulfonated bisphenols might corrode metals, and their usage is restricted. Further, polymer binders including NH₄+ ion instead of alkaline ions may similarly swell due to osmotic pressures, might generate NH₃, and are not preferable.

By the way, polymethacrylic methyl resin is not substantially hydrophilic, while including ester group, and therefore, reduces the gas sensor sensitivities in dry atmospheres (FIGS. 9 and 10). Similarly, polyamide fibers (6-6 nylon fibers) include amido groups but are not substantially hydrophilic and reduce the gas sensor sensitivities in dry atmospheres.

Further preferably, said organic binder includes hydroxy group or ether group. Such organic binders include, for example, cellulose, PVA (polyvinyl alcohol), polyolefin glycol (for example, polyethylene glycol, or polypropylene glycol), hemicellulose, and alginic acid. Further, the hydroxy group in the cellulose may be partly esterified, and the species of the cellulose is arbitrary. Since PVA, polyethylene glycol, polypropylene glycol, hemicellulose, alginic acid, and so on, are water-soluble, preferably, they are made water-insoluble, for example, by bridging. When the organic binder is water-insoluble, they do not migrate in dew condensed atmospheres so that the durability in dew condensed atmospheres improves. Particularly preferable binders are cellulose and PVA, hemicellulose, and alginic acid that are water-insoluble. In these binders, cellulose and water-insoluble PVA are particularly preferable. Further, PVA may be a copolymer with vinyl acetate. The inventor has confirmed that when a cellulose or water-insoluble PVA binder is used, the changes in sensor performances are small after a ten weeks aging in a dew condensed atmosphere of 50° C. (FIG. 5).

Preferably, said first gas diffusion layer and said second gas diffusion layer are made hydrophilic by a hydrophilic carbon. For example, when active carbon is treated with a mixture of concentrated sulfuric acid and an oxidizing agent or a mixture of concentrated nitric acid and an oxidizing agent, it may keep water no less than silica-gel in low humidity regions (the patent document 3: JP2010-241648A). Such active carbon has an electric conductivity enough for the gas diffusion layers in electrochemical gas sensors and improves the durability of gas sensors in dry atmospheres by hydrophilization (Ta. 2). Carbon fiber, graphite, and carbon black may be made hydrophilic by the similar process.

When a reference electrode is provided, it is provided, for example, on the same surface of the polymer solid electrolyte membrane as the counter electrode. The polymer solid electrolyte membrane may be proton conductive or anion conductive and preferably is proton conductive. The conductive carrier may be proton or an alkali ion.

In many electrochemical gas sensors, atmospheres are supplied in the order of a filter, a gas diffusion layer in the vicinity of the detection electrode, and the detection electrode. Poisonous gases such as siloxanes that reduce the catalytic activity of the detection electrode are removed by the filter. The filter comprises, for example, active carbon and is a larger element in volume than the gas diffusion layer. The inventor has found that a hydrophilic active carbon filter improves the durability of electrochemical gas sensors in dry atmospheres and keeps the gas sensitivity in dew condensed atmospheres.

FIG. 12 to FIG. 14 indicate performances of gas sensors provided with a hydrophilic filter comprising active carbon and a hydrophilic polymer, in a dew condensed atmosphere (FIG. 12) and in dry atmospheres (FIG. 13 and FIG. 14). While the active carbon filter was hydrophilic, the gas sensitivity loss due to the water condensation in the filter did not occur even in the dew condensed atmosphere (FIG. 12). Further, the gas sensors were able to detect gas steadily for 10 weeks in a dry atmosphere of 70° C. (FIG. 14).

FIG. 15 to FIG. 17 indicate the sensor performances provided with a filter comprising active carbon made hydrophilic by oxidation. In dew condensed atmosphere, the gas was reliably detected for ten weeks (FIG. 15), and, in a dry atmosphere of 70° C., the gas was reliably detected for ten weeks (FIG. 17).

FIG. 18 and FIG. 19 indicate the sensor performances provided with a usual active carbon filter, and the gas sensitivities decreased gradually in dry atmospheres of 50° C. (FIG. 18) and 70° C. (FIG. 19).

These data indicate that hydrophilic active carbon filters enhance the durability in hot dry atmospheres and do not hinder the gas sensitivity in dew condensed atmospheres. The water held in the hydrophilic active carbon filter is attributed to the enhanced durability in hot dry atmospheres. The reason why gas sensitivity in dew condensed atmospheres was not decreased is not clear, however, this phenomenon is common in both an active carbon filter including a hydrophilic polymer and an active carbon filter where the active carbon itself is made hydrophilic. Therefore, such a filter improves the reliability of electrochemical gas sensors without a water reservoir in dry atmospheres and keeps the sensitivity in dew condensed atmospheres.

Particularly preferably, the active carbon filter is a shaped body of the active carbon and the hydrophilic polymer binder. The shaped active carbon filter may be easily handled and does not contaminate the surroundings even when powder-like active carbon is used.

Preferably, the active carbon filter comprises an active carbon which may be hydrophilic or hydrophobic and a hydrophilic polymer. The hydrophilic polymer may be cellulose, PVA (polyvinyl alcohol), vinyl acetate polymer, a copolymer of PVA and vinyl acetate, hemicellulose, starch, pectin, alginic acid, polyvinyl pyrrolidone, polyacryl amide, polyacrylic acid, polymethacrylic acid, polymaleic acid, sulfonated condensed biphenols, lignin, and so on. These hydrophilic polymers include a hydrophilic group, such as a hydroxy group, an ether group, a carboxylic group, a ketone group, an amido group, sulfonic acid group, a sulfonyl group, an ester group. The degree of hydrophilicity depends mainly on the content of the hydrophilic group, and the species of the hydrophilic groups and the stability of the polymer crystals influence the hydrophilicity. For example, hydroxy group is more hydrophilic than ester group.

Most preferably, the hydrophilic polymer is cellulose, PVA (polyvinyl alcohol), vinyl acetate polymer, a copolymer of PVA and vinyl acetate, hemicellulose, starch, pectin, alginic acid, polyvinyl pyrrolidone, or polyacryl amide. These polymers are in a range from weakly basic to weakly acidic and are easily handled. As shown in FIG. 2 to FIG. 4, they improve the durability in dry atmospheres and maintain the sensitivity in dew condensed atmospheres.

The mass ratio of the active carbon and the hydrophilic polymer is preferably the active carbon from 90 to 50 mass %: the hydrophilic polymer from 10 to 50 mass %. The active carbon may be fiber-like, powder-like, or granular.

Preferably, the active carbon filter includes oxidized and hydrophilic active carbon. The oxidized and hydrophilic active carbon is different from other active carbons in that it includes an acidic group such as sulfuric acid group, nitric acid group, and phosphoric acid group and that it holds plenty of water in dry atmospheres. It has been reported when active carbon is oxidized with a mixture of condensated sulfuric acid and an oxidizing agent or a mixture of condensated nitric acid and an oxidizing agent, the active carbon may hold in low humidity regions no less quantity of water than silica gel (the patent document 3: JP2010-241648A). In this specification, active carbons oxidized by a mixture of an acid and an oxidizing agent and so on are called active carbons made hydrophilic by oxidation. Further, it is known that active carbons treated with a strong acid absorb siloxane compounds (the patent document 4: JP2007-503992).

Thus, active carbons made hydrophilic by oxidation enhance the durability of gas sensors against drying in dry regions due to the held water and prevent more reliably the poisoning of the detection electrode due to the acid treatment

### BRIEF DESCRIPTION OF THE DRAWINGS

FIG. 1 Sectional view of electrochemical gas sensors according to embodiments 1 and 2

FIG. 2 Partially enlarged view of FIG. 1

FIG. 3 Characteristic diagram indicating gas sensor output according to an embodiment (cellulose+PVA binder) in a dry atmosphere of 50° C.

FIG. 4 Characteristic diagram indicating gas sensor output according to the embodiment (cellulose+PVA binder) in a dry atmosphere of 70° C.

FIG. 5 Characteristic diagram indicating gas sensor output according to the embodiment (cellulose+PVA binder) in a wet atmosphere of 50° C.

FIG. 6 Characteristic diagram indicating gas sensor output according to a comparative example (PTFE binder) in the dry atmosphere of 50° C.

FIG. 7 Characteristic diagram indicating gas sensor output according to the comparative example (PTFE binder) in the dry atmosphere of 70° C.

FIG. 8 Characteristic diagram indicating gas sensor output according to the comparative example (PTFE binder) in the wet atmosphere of 50° C.

FIG. 9 Characteristic diagram indicating gas sensor output according to a comparative example (acrylic resin binder) in the dry atmosphere of 50° C.

FIG. 10 Characteristic diagram indicating gas sensor output according to the comparative example (acrylic resin binder) in the dry atmosphere of 70° C.

FIG. 11 Sectional view of electrochemical gas sensors according to embodiments 3 and 4

FIG. 12 Characteristic diagram indicating gas sensor output according to the embodiment 3 (cellulose+PVA binder) in the wet atmosphere of 50° C.

FIG. 13 Characteristic diagram indicating gas sensor output according to the embodiment 3 (cellulose+PVA binder) in the dry atmosphere of 50° C.

FIG. 14 Characteristic diagram indicating gas sensor output according to the embodiment 3 (cellulose+PVA binder) in the dry atmosphere of 70° C.

FIG. 15 Characteristic diagram indicating gas sensor output according to the embodiment 4 (active carbon made hydrophilic by oxidation) in the wet atmosphere of 50° C.

FIG. 16 Characteristic diagram indicating gas sensor output according to the embodiment 4 (active carbon made hydrophilic by oxidation) in the dry atmosphere of 50° C.

FIG. 17 Characteristic diagram indicating gas sensor output according to the embodiment 4 (active carbon made hydrophilic by oxidation) in the dry atmosphere of 70° C.

FIG. 18 Characteristic diagram indicating gas sensor output according to a comparative example (active carbon not made hydrophilic) in the dry atmosphere of 50° C.

FIG. 19 Characteristic diagram indicating gas sensor output according to the comparative example (active carbon not made hydrophilic) in the dry atmosphere of 70° C.

### DETAILED DESCRIPTION OF THE PREFERRED EMBODIMENTS

Optimal embodiments for carrying out the invention are described.

### Embodiment

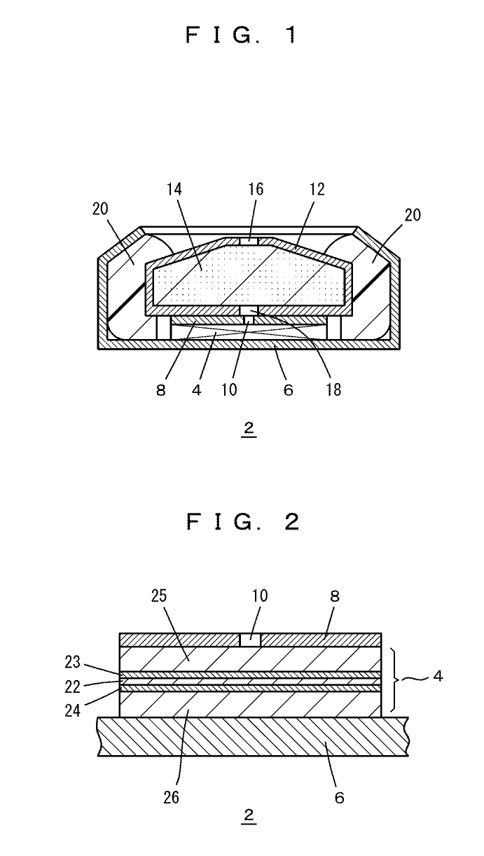

FIGS. 1 and 2 indicate an electrochemical gas sensor 2 according to an embodiment. In the drawings, indicated at 4 is an MEA, at 6 is a metal can made of stainless steel and so on, and at 8 is a diffusion control plate that has a diffusion control hole 10 having a constant diameter to introduce atmosphere to be detected to the MEA 4. Indicated at 12 is a sealing member that accommodates a filter material 14 such as active carbon, takes an atmosphere to be detected through an opening 16, and diffuses the atmosphere through an opening 18 to the diffusion control hole 10. Further, a gasket 20 insulates the metal can 6 and the sealing member 12 air-tightly.

As shown in FIG. 2, the MEA 4 comprises a proton conductor membrane 22 having a thickness of 20 μm, a detection electrode 23 having a thickness of 10 μm, a counter electrode 24 having a thickness of 10 μm, laminated on the both surfaces of the membrane, and gas diffusion layers 25, 26 having a thickness of 200 μm and sandwiching the electrodes. Further, the detection electrode 23 and the gas diffusion layer 25 are positioned at the side of atmosphere to be detected, the counter electrode 24 and the gas diffusion layer 26 are positioned at the side of the metal can 6. The proton conductor membrane 22 comprises a fluorocarbon resin incorporating sulfonic acid groups and has a preferable thickness not less than 5 μm and not more than 50 μm. The detection electrode 23 and the counter electrode 24 include a carbon material such as carbon black or active carbon supporting a catalyst such as Pt or Pt—Ru, and a proton conductor polymer dispersed in the carbon and have a preferable thickness not less than 1 μm and not more than 10 μm. When the detection electrode 23 and the counter electrode 24 are thin film electrodes, the thickness is made not less than 0.1 μm and not more than 1 μm. Further, in place of the proton conductor membrane 22, an anion conductor membrane, such as a hydroxide ion conductor, may be used.

The gas diffusion layers 25, 26 are sheet-like and comprise a carbon material, such as carbon black, carbon fiber, or graphite, bound with a hydrophilic polymer binder, porous and electrically conductive, and have a preferable thickness not less than 20 μm and not more than 400 μm. The gas diffusion layers 25, 26, preferably, have the hydrophilic polymer not less than 10 mass % and not more than 50 mass % in concentration and the carbon not less than 50 mass % and not more than 90 mass % in concentration. Further, only one of the gas diffusion layers 25, 26 may be made hydrophilic.

The structure of the electrochemical gas sensor is arbitrary, and a synthetic resin housing may be used in place of the metal can 6 and the sealing member 12. In this case, leads extending to the outside of the housing are connected to the detection electrode 23 and the counter electrode 24. Further, the detection electrode 23 and the counter electrode 24 may be separately arranged on one surface of the proton conductor membrane 22. In this case, the detection electrode 23 may be positioned at the center of the proton conductor membrane 22, and the atmosphere to be detected may be supplied from the diffusion control hole 10 to the detection electrode 23. Further, for example, a ring-like counter electrode 24 surrounding the detection electrode 23 is provided on the same surface of the proton conductor membrane 22. And the gas diffusion layer 25 may be impregnated with resin in a ring-like shape between the detection electrode 23 and the counter electrode 24 so as to seal the atmosphere between the detection electrode 23 and the counter electrode 24. In this case, the gas diffusion layer 26 is not necessary.

The gas diffusion layers 25, 26 are made hydrophilic, for example, by

a binder comprising a hydrophilic polymer and combining the carbon (embodiment 1, comparative examples 1, 2), or

oxidation of the carbon in order to make the carbon hydrophilic (embodiment 2).

### Embodiment 1

A 60 mass % of carbon black and a binder comprising hydroxy cellulose fiber 20 mass % and a fiber-like PVA 20 mass %, made water-insoluble by bridging were blended and formed to the sheet-like gas diffusion layers 25, 26 having a thickness of 200 μm. A gas sensor with these gas diffusion layers is called embodiment 1. An 80 mass % of the carbon black was bound by a 20 mass % of PTFE (polytetrafluoro ethylene) to form the gas diffusion layers 25, 26 having a thickness of 200 μm. A gas sensor with these gas diffusion layers is called comparative example 1. Further, a 60 mass % of carbon fiber was bound by a binder comprising poly-methyl methacrylate resin 20 mass % and PET (polyethylene terephthalate) 20 mass % to form the gas diffusion layers 25, 26 having a thickness of 200 μm. A gas sensor with these gas diffusion layers is called comparative example 2.

For the respective gas sensors (sample number N=5), initial output currents were measured for CO concentrations at 20° C. and at 50% RH. Then, the respective gas sensors were aged for 10 weeks in a dry atmosphere at 50° C. (10% RH) and in a dry atmosphere at 70° C. (4% RH). During the agings, the gas sensors were taken out of the dry atmospheres and transferred into an atmosphere of 20° C. 50% RH and kept in the atmosphere for 1 hour. Then, the CO sensitivities were measured, and after that, the gas sensors were retransferred into the dry atmospheres. The initial output currents at 1000 ppm CO were defined as I₀, and the transitions of the output currents for the ten weeks were measured. Further, the transitions of the CO sensitivities in a wet atmosphere of 50° C. 100% RH were similarly measured. The transitions of CO sensitivities are indicated by the ratio of output currents I at 1000 ppm CO:their initial values I₀. These tests were performed as accelerated tests indicating the endurance in dry atmospheres and also the endurance in wet atmospheres. Further, when the gas sensors were kept in an atmosphere of 20° C. 50% RH for 24 hours after the tests, the sensitivities of respective gas sensors recovered to the initial values.

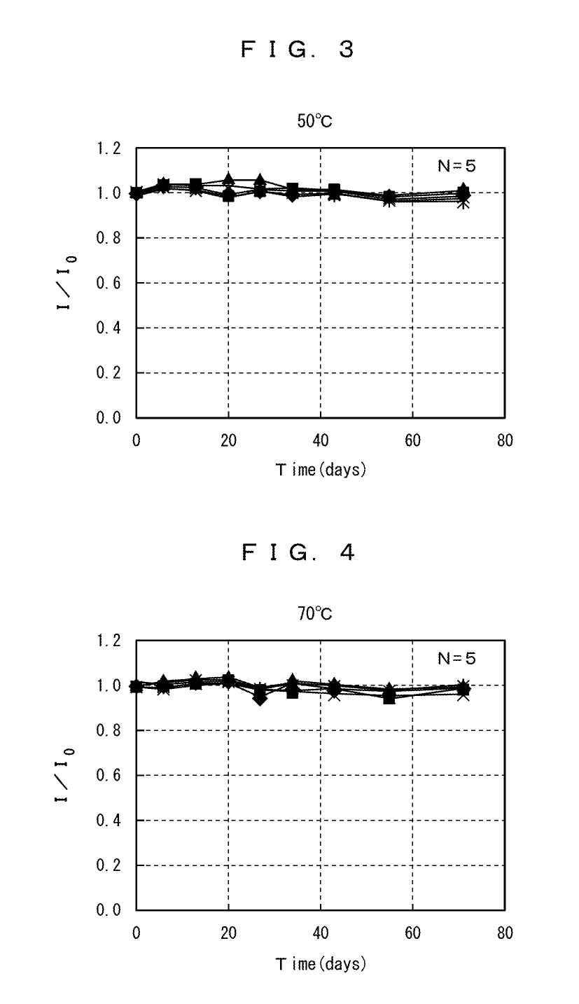

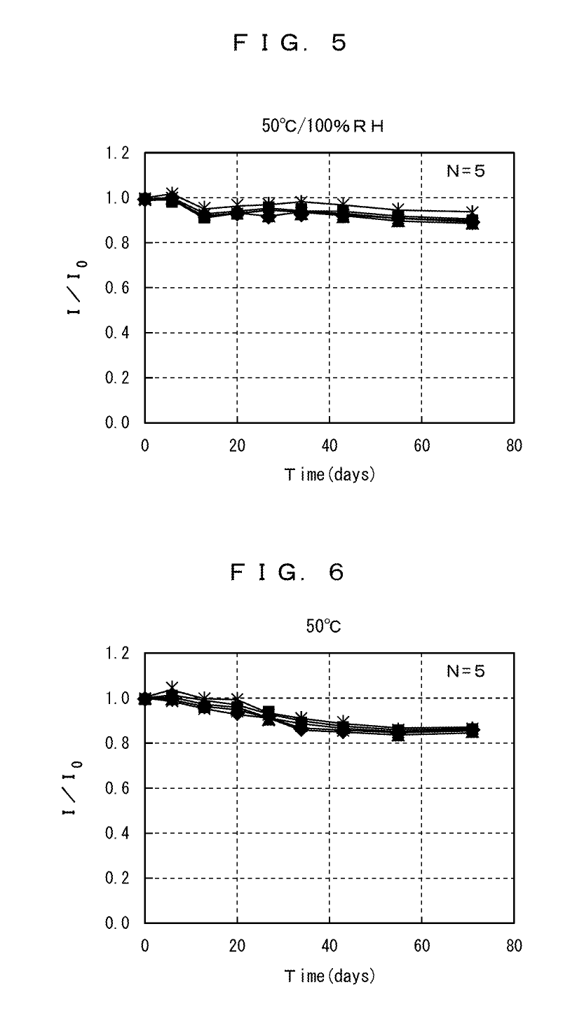

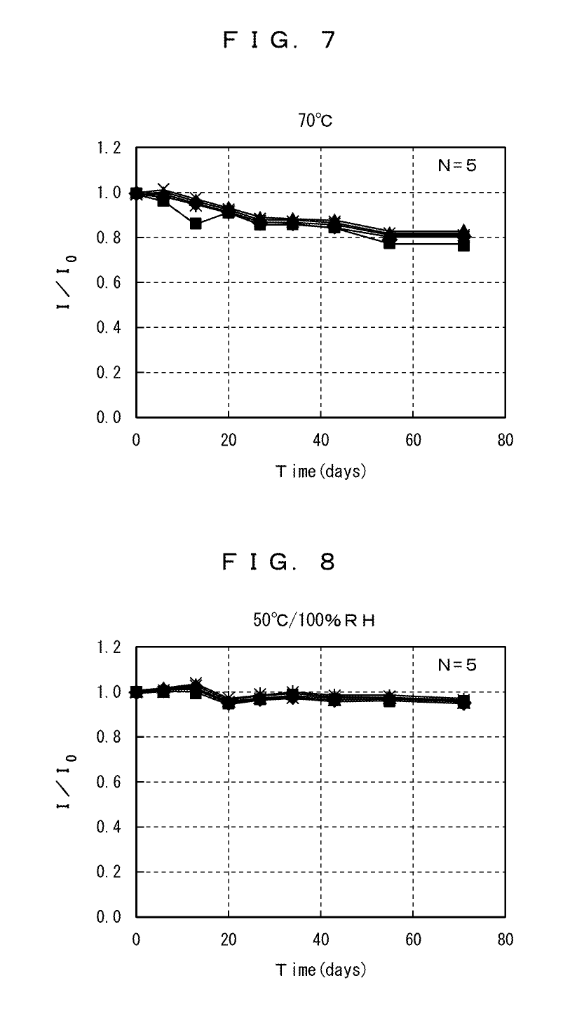

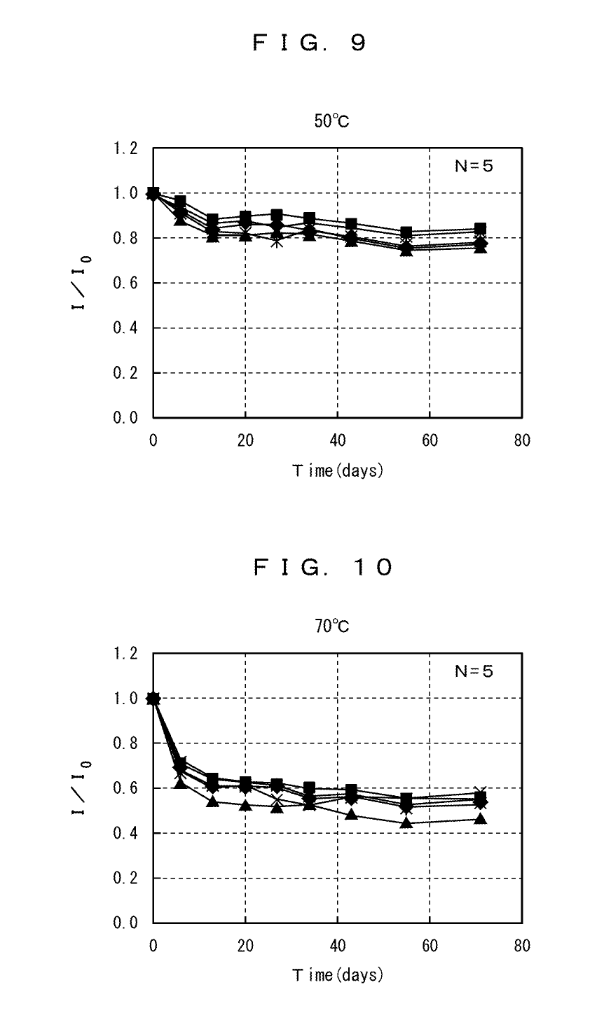

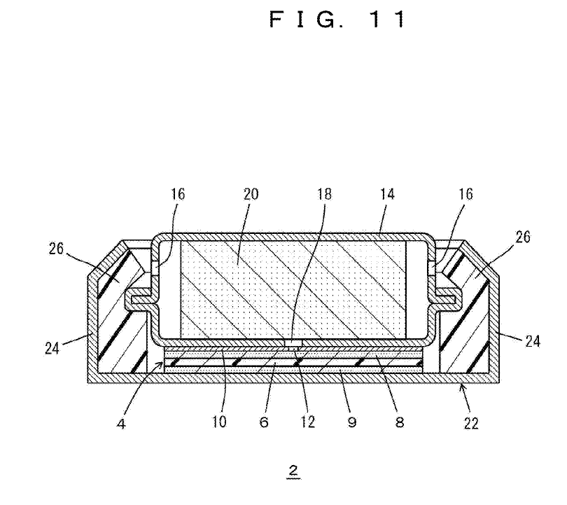

The results regarding the embodiment 1 are indicated in FIGS. 3-5, the results regarding the comparative example 1 are in FIGS. 6-8, and the results regarding the comparative example 2 in the dry hot atmospheres are in FIGS. 9 and 10. Regarding the embodiment 1, the CO sensitivities did not decrease for 10 weeks in the 70° C. 4% RH atmosphere and further, the CO sensitivities almost did not decrease for 10 weeks in the 50° C. 100% RH atmosphere. This indicates that water condensation in the gas diffusion layers 25, 26 did not occur in the dew condensed atmosphere, and therefore, the gas sensitivities were not lost. Further, both the mixture of the carbon black and the cellulose and the mixture of the carbon black and a copolymer of PVA and vinyl acetate showed the similar endurance performance to the dew condensed atmosphere. In contrast to them, in the comparative example 1, both the CO sensitivities at 70° C. 4% RH and at 50° C. 10% RH decreased. Further, in the comparative example 2, the CO sensitivities decreased more remarkably than the comparative example 1.

Various gas sensors different in the species of carbon and its concentrations and the species of binders and its concentrations were aged for 10 weeks in 50° C.10% RH, and then their CO sensitivities were similarly measured; the results are indicated in Table 1. Five sensors were tested respectively, the result is indicated by the average, and the specimen with the * mark indicates a comparative example.

Ta. 1

| Species of Carbon | Species of Binder and | Sensitivity after |
|---|---|---|
| and Concentration (mass %) | Concentration (mass %) | 10 weeks (I/I₀) |
| Carbon Fiber 60 | Hydroxy Cellulose 40 | 1.0 |
| Powde-like Active Carbon 80 | PVA-vinyl acetate | 1.0 |
| | copolymer 20 | |
| | saponification | |
| | degree60% | |
| Carbon Fiber 60* | 6-6 nylon 40* | 0.8 |

### Embodiment 2

According to the patent document 3, powder-like active carbon was made hydrophilic by concentrated sulfuric acid and potassium manganate. Gas diffusion layers 25, 26 having a thickness of 200 μm were prepared with the usage of 80 mass % of the active carbon and 20 mass % of PTFE binder and incorporated into the gas sensor 2. The CO sensitivity after the aging of 10 weeks in an atmosphere of 50° C. 10% RH is indicated in Table 2. The sensor number was five, and the result is indicated by the average. Fiber-like active carbon may be made hydrophilic.

Ta. 2

| | Species of Binder | |
|---|---|---|
| Species of Carbon | and Concentration | Sensitivity |
| and Concentration (mass %) | (mass %) | after 10 weeks (I/I₀) |
| Hydrophilic Active Carbon 80 | PTFE 20 | 1.0 |

In the embodiments, the diffusion control hole 10 restricts the water vapor transfer between MEA 4 and surrounding atmospheres. This contributes the property that a small quantity of water in the gas diffusion layers 25, 26 provides the long-term durability in the dry atmospheres. Thus, the invention is particularly effective to those electrochemical gas sensors that control the diffusion between MEA 4 and surrounding atmospheres. Further, when the binder swells or migrates as a water solution in a dew condensed atmosphere, the diffusion control hole 10 might be blocked or the properties of the gas diffusion layers 25, 26 might be changed. Therefore, water-insoluble binders not containing alkaline metal ions are used to enhance the durability in dew condensed atmospheres. Further, binders having hydroxy groups or ether groups as the hydrophilic groups enhance particularly the durability in dew condensed atmospheres.

The Structure of Gas Sensors According to Embodiment 3, 4

FIG. 11 shows an electrochemical gas sensor 2 according to embodiments 3 and 4. In the drawing, indicated at 4 is an MEA comprising a proton conductor membrane 22 having a thickness of 20 μm, a detection electrode and a counter electrode covering the both surfaces of the membrane, and gas diffusion layers 25, 26 sandwiching them. The proton conductor membrane 22 comprises a fluoro resin where sulfonic acid groups are introduced and has preferably a thickness not less than 5 μm and not more than 50 μm. The detection electrode and the counter electrode comprise a carbon such as carbon black and active carbon supporting a catalyst such as Pt, Pt—Ru and proton conductive polymer dispersed therein and have preferably a thickness not less than 0.1 μm and not more than 10 μm. Further, in place of the proton conductor membrane 22, an anion conductor membrane such as hydroxide ion conductor membrane may be used. The gas diffusion layers 25, 26 comprise sheets of carbon black bound with PTFE (polytetrafluoro ethylene), are porous and electrically conductive, and have preferably a thickness not less than 20 μm and not more than 400 μm.

Indicated at 8 is a diffusion control plate that has a diffusion control hole 10 having a constant diameter for introducing the atmosphere to be detected to the gas diffusion layer 25 of the MEA 4. Indicated at 12 is a metal sealing member that accommodates active carbon filter 14, takes atmosphere to be detected through an opening 16 and diffuses it to the diffusion control hole 10 through an opening 18. Indicated at 6 is a metal can that accommodates the MEA 4 and the sealing member 12 and fixes the sealing member 12, the MEA 4, and the diffusion control plate 8 air-tightly by a gasket 20 with caulking. As a result, the sealing member 12 is connected to the detection electrode, and the metal can 6 is connected to the counter electrode. Further, indicated at 7 is a side wall of the metal can 6.

The structure of the electrochemical gas sensor is arbitrary, and a synthetic resin housing and synthetic resin cap may be used in place of the metal can 6 and the sealing member 12. In this case, the cap accommodates the active carbon filter 14 so as to introduce the atmosphere to be detected into the detection electrode. Further, a pair of leads are connected to the detection electrode and the counter electrode and are extended outside of the housing and the cap. Further, the detection electrode and the counter electrode may be arranged separately from each other on the same surface of the proton conductor membrane 22. In this case, the detection electrode is arranged at the center of the proton conductor membrane 22 and supplied the atmosphere to be detected through the diffusion control hole 10. Further, a ring-like counter electrode which surrounds the detection electrode is arranged on the same surface of the proton conductor membrane 22. Further, the gas diffusion layer 25 is impregnated with a resin in a ring-like shape between the detection electrode and the counter electrode so that the detection electrode and the counter electrode are kept airtight. Further, in this case, the gas diffusion layer 26 is not necessary.

The active carbon filter 14 may be made hydrophilic, for example, by a hydrophilic binder which binds the active carbon (embodiment 3) or by making the active carbon oxidized to make the active carbon hydrophilic (embodiment 4). By the way, beads of hydrophilic polymer may be dispersed with the active carbon; however, the beads have no other functions than the hydrophilization of the filter. On the contrary, the hydrophilic polymer binder is effective in the shaping of the active carbon filter, and therefore, the active carbon filter may be easily handled.

### Embodiment 3

A 70 mass % of powder-like active carbon was mixed with a 15 mass % of hydroxy cellulose fiber and a 15 mass % of fiber-like PVA (polyvinyl alcohol) that was made water-insoluble by bridging, and the mixture was shaped into a disc of 7 mm diameter and 2 mm thickness as the active carbon filter 14. The filter 14 was air permeable and had a constant disc-like shape due to the binder comprising the hydroxy cellulose and the PVA. As a comparative example, an 80 mass % of powder-like active carbon was mixed with a 20 mass % of PTFE (polytetrafluoro ethylene) binder and shaped to a shaped active carbon filter of the same size. The active carbon may be fiber-like or granular.

### Embodiment 4

An 80 mass % of powder-like active carbon the surface of which was oxidized and made hydrophilic by concentrated sulfonic acid and potassium permanganate according to the patent document 3 and a 20 mass % of PTFE binder were used to shape an active carbon filter 14 that had the same size to that of the embodiment 3. Further, when a hydrophilic binder is used in place of the PTFE binder, more advantageous effects will be resultant. The active carbon may be fiber-like or granular.

For the respective gas sensors, the initial output currents I₀ for a CO concentration were measured in an atmosphere of 20° C., 50% RH (dew point: 10° C.). Then, the respective gas sensors were aged in a dry atmosphere of 50° C. (10% RH) for ten weeks and also aged in a dry atmosphere of 70° C. (4% RH) for ten weeks. During the agings, the gas sensors were taken out of the aging atmospheres into an atmosphere of 20° C., 50% RH, the CO sensitivities were measured after waiting for 1 hour in the normal atmosphere, and then the gas sensors were returned into the dry atmospheres. In this way, the initial output currents I₀ for 1000 ppm CO and the transitions of the output currents I for the ten weeks were measured. Further, the transitions of the CO sensitivities in a wet atmosphere of 50° C., 100% RH were similarly measured. The transitions of the CO sensitivities are indicated by I/I₀, the ratio of the output currents in 1000 ppm CO atmospheres I and their initial values I₀. These tests were performed as an accelerated test for the durabilities in dry atmospheres and in wet atmospheres, and the sensor number was 5. Further, when the gas sensors were kept in an atmosphere of 20° C., 50% RH for 24 hours, then the sensitivities of the gas sensors recovered to the initial values I₀.

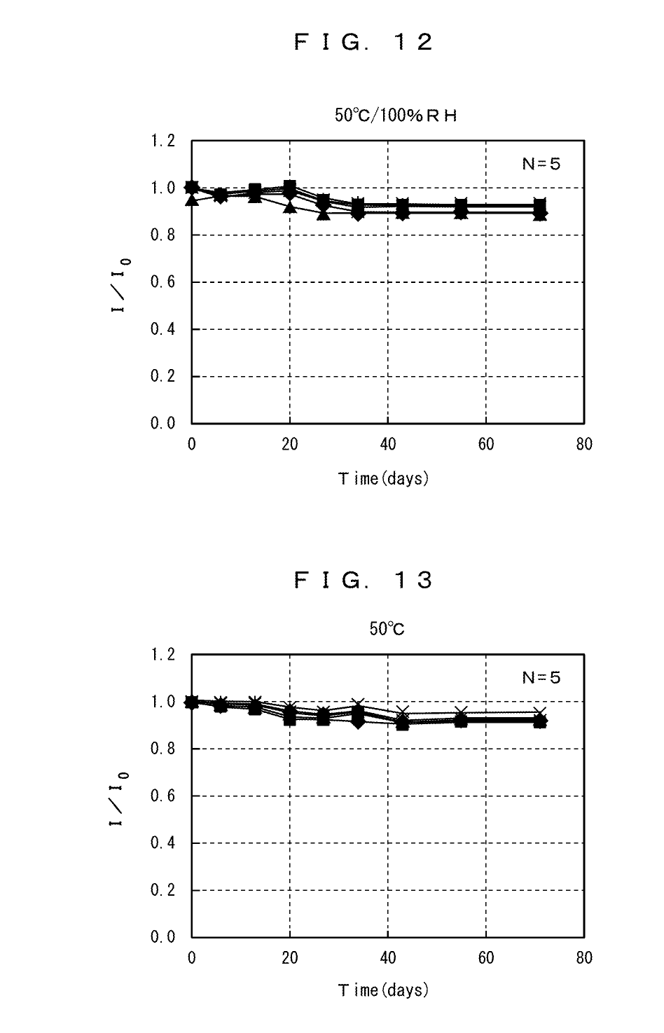

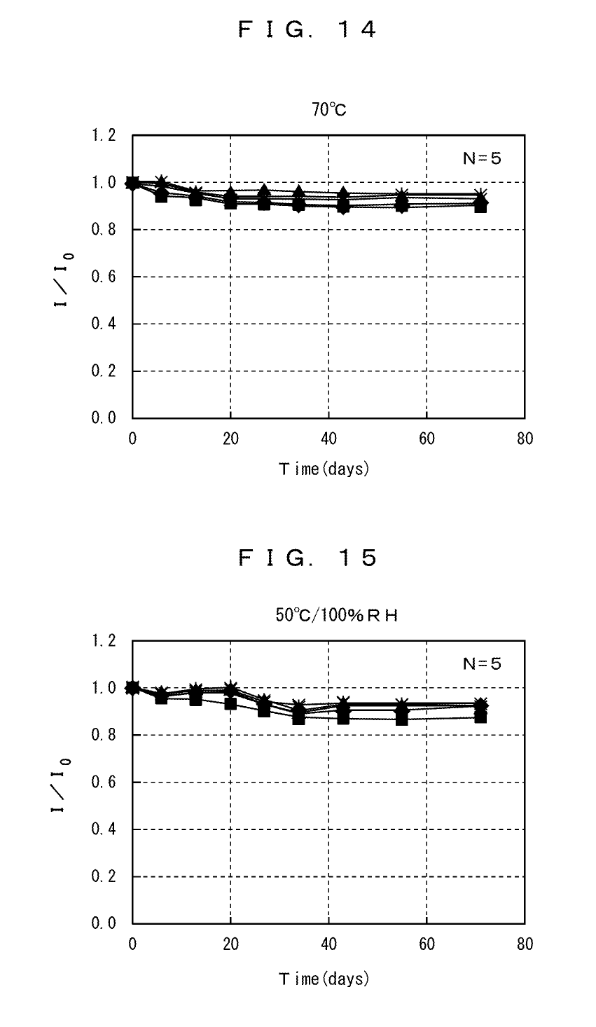

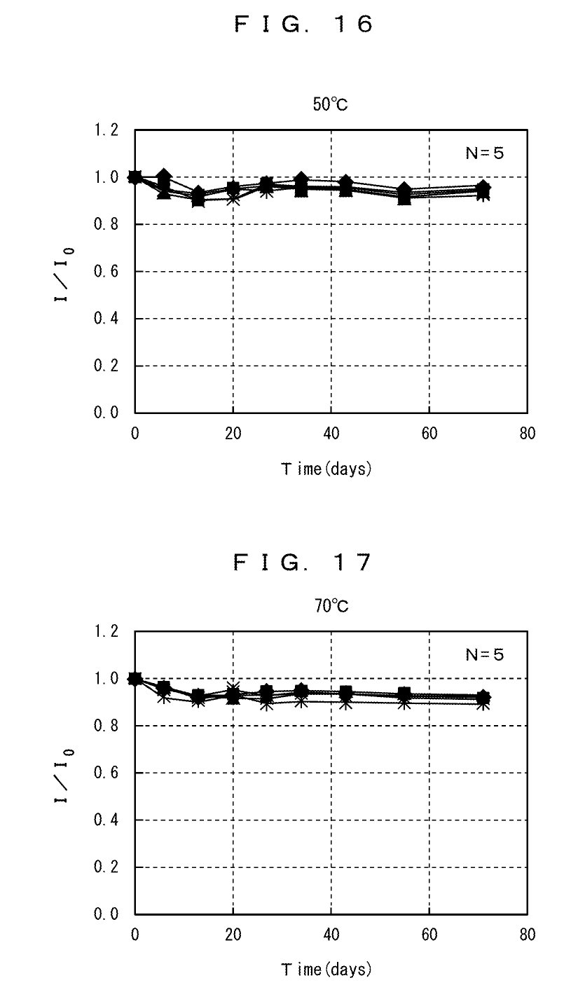

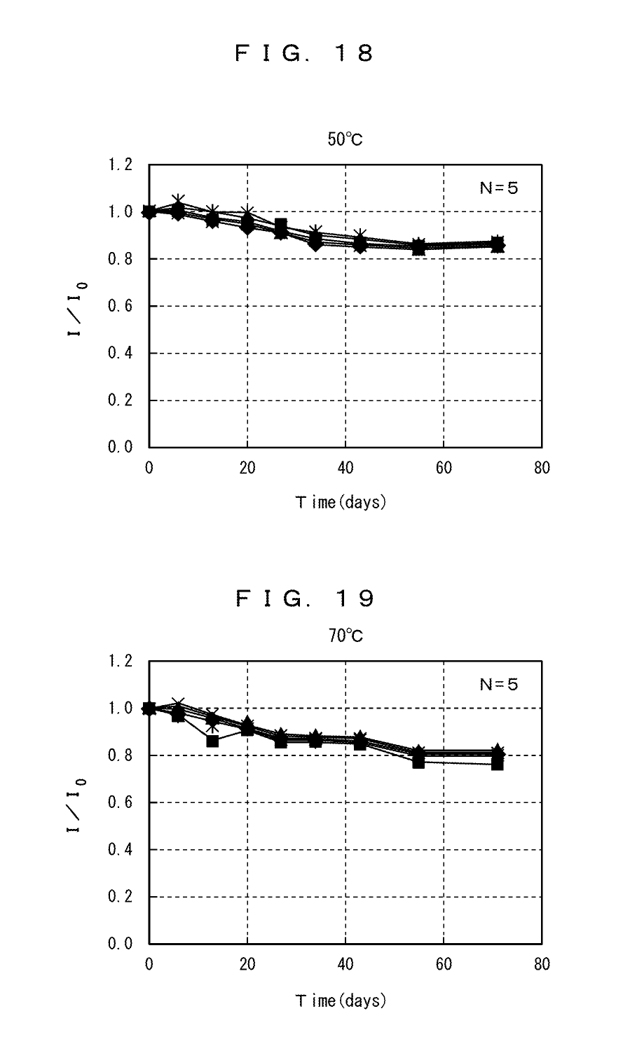

The results in the embodiment 3 are indicated in FIG. 12 to FIG. 14, the results in embodiment 4 in FIG. 15 to FIG. 17, and the results in the comparative example in FIG. 18 and FIG. 19. In the embodiments 3 and 4, the decreases in the CO sensitivities were small during 10 weeks in the atmosphere of 70° C., 4% RH and also small during 10 weeks in the atmosphere of 50° C., 100% RH. This means that the gas sensitivities in the dry high-temperature atmosphere were maintained due to the plenty of water in the active carbon filter 14 and that the active carbon filter 14 does not be blocked nor flooded in the dew condensed atmosphere. On the contrary, in the comparative example, the CO sensitivities decreased both in the 70° C., 4% RH and 50° C., 10% RH but were maintained in the 50° C. dew condensed atmosphere. Further, an active carbon filter where powder-like active carbon was bound by cellulose and also an active carbon filter where powder-like active carbon was bound by a copolymer of PVA and polyvinyl acetate showed the similar durabilities to the embodiment 3 in the dry atmosphere and the dew condensed atmosphere.

Further, non-hydrophilic binders, namely, poly-methyl acrylate and 66 nylon were tested in place of PTFE, but no better durabilities in the dry atmosphere than the comparative example were observed.

### DESCRIPTION OF SYMBOLS

2 electrochemical gas sensor
4 MEA
6 metal can
8 diffusion control plate
10 diffusion control hole
12 sealing member
14 filter material
16, 18 opening
20 gasket
22 proton conductor membrane
23 detection electrode
24 counter electrode
25, 26 gas diffusion layer

1. An electrochemical gas sensor comprising a polymer solid electrolyte membrane, a detection electrode in contact with said solid electrolyte membrane, a counter electrode in contact with said solid electrolyte membrane and not in contact with the detection electrode, an electrically conductive and porous gas diffusion layer covering the detection electrode in an opposite side to said solid electrolyte membrane, and a filter;
wherein the electrochemical gas sensor is not provided with a water-reservoir; and
wherein the gas diffusion layer or the filter is hydrophilic.

2. The electrochemical gas sensor according to claim 1, wherein the diffusion layer is hydrophilic.

3. The electrochemical gas sensor according to claim 2, wherein said detection electrode is provided on one surface of said solid electrolyte membrane;
wherein said counter electrode is provided on the other surface of said solid electrolyte membrane;
wherein said gas diffusion layer covering said detection electrode is a first gas diffusion layer;
wherein the electrochemical gas sensor further comprises a second gas diffusion layer which is electrically conductive and porous and covers said counter electrode in an opposite side to said solid electrolyte membrane; and
wherein said first gas diffusion layer and said second gas diffusion layer are both hydrophilic.

4. The electrochemical gas sensor according to claim 3, wherein both said first gas diffusion layer and said second gas diffusion layer include a hydrophilic organic binder free of alkaline metal ions and comprising a water-insoluble hydrophilic polymer.

5. The electrochemical gas sensor according to claim 4, wherein said organic binder includes hydroxy group or ether group.

6. The electrochemical gas sensor according to claim 3, wherein both said first gas diffusion layer and said second gas diffusion layer comprise a binder and a hydrophilic carbon.

7. The electrochemical gas sensor according to claim 1, wherein said filter comprises a hydrophilic active carbon.

8. The electrochemical gas sensor according to claim 7, wherein said active carbon filter comprises active carbon and a hydrophilic polymer.

9. The electrochemical gas sensor according to claim 8, wherein said active carbon filter is a shaped body of the active carbon and a binder comprising the hydrophilic polymer.

10. The electrochemical gas sensor according to claim 9, wherein said active carbon filter includes hydrophilic active carbon.
